(19) United States
(12) Patent Application Publication
(10) Pub. No.: US 2012/0145427 A1
(43) Pub. Date: Jun. 14, 2012

(54) Handheld Power Tool, in Particular Power Drill or Power Screwdriver

(75) Inventor: Rudolf Fuchs, Neuhausen (DE)

(73) Assignee: Robert Bosch GmbH, Stuttgart (DE)

(21) Appl. No.: 13/325,025

(22) Filed: Dec. 13, 2011

(30) Foreign Application Priority Data
Dec. 14, 2010 (DE) 10 2010 063 069.1

(51) Int. Cl. B25F 5/00

(52) U.S. Cl. 173/216

(57) ABSTRACT

A handheld power tool, in particular, a power drill or a power screwdriver is disclosed. The handheld power tool includes a housing which includes a first region for a tool holder and a second region which serves as a handle. The tool holder is coupled to a drive motor by a gear mechanism. Both the drive motor and a switching device for operating the drive motor is arranged in the second region of the housing. Provision is made for the drive motor to be arranged in the second region of the housing on the side which faces the gear mechanism.

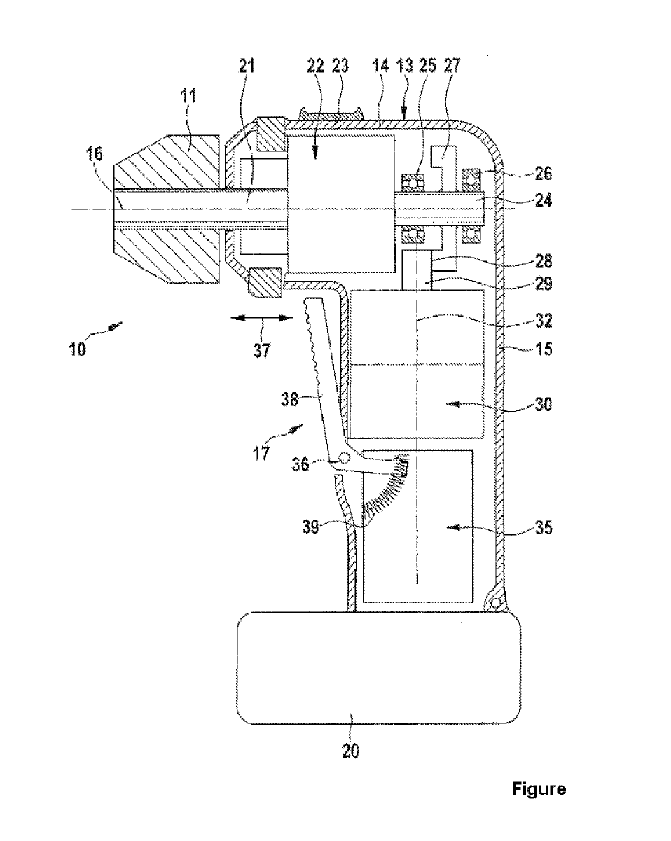

This application claims priority under 35 U.S.C. §119 to patent application no. DE 10 2010 063 069.1, filed on Dec. 14, 2010 in Germany, the disclosure of which is incorporated herein by reference in its entirety.

### BACKGROUND

The disclosure relates to a handheld power tool, in particular a power drill or a power screwdriver.

A handheld power tool of this kind is already known from practice, with a gear mechanism being arranged in the housing of the handheld power tool in a first housing region as an extension of a tool holder and being driven by a drive motor by means of a drive shaft. In this case, the drive motor, together with a switching unit, is located in a second housing region of the handheld power tool, which housing region at the same time serves as a handle and is arranged substantially perpendicular to the first housing region. In this case, it is important for the switching unit to be located between the gear mechanism and the drive motor, and therefore a relatively long drive shaft is required to bridge the distance between the drive motor and the gear mechanism. As a result, the second housing region has a relatively large cross section on account of the drive shaft, and the transmission of force by means of the drive shaft is relatively complicated and therefore cost-intensive on account of the bearings required to support the drive shaft. A further disadvantage which can be mentioned is that relatively long connecting cables are required to bridge the distance between a battery pack which is arranged at the lower end of the second housing region and the switching unit, said connecting cables additionally making it more difficult to make electrical contact with the handheld power tool or its drive and increasing the expenditure.

### SUMMARY

Proceeding from the described prior art, the features of the disclosure are based on the object of developing a handheld power tool, in particular a power drill or a power screwdriver in such a way that the handheld power tool can be designed in as compact a manner as possible. In addition, the structural outlay in respect of coupling the drive motor to the gear mechanism should be as simple as possible and it should be possible to produce the handheld power tool in a cost-effective manner.

This object is achieved with a handheld power tool, in particular a power drill or a power screwdriver, having the features set forth below. In this case, the features of the disclosure are based on the idea of, as a result of arranging the drive motor between the switching unit and the gear mechanism, positioning the drive motor close to the gear mechanism in such a way that a relatively simple and therefore also cost-effective way of transmitting force from the drive motor to the gear mechanism is made possible. In this case, it is possible, in particular, to dispense with, for example, relatively long drive shafts which additionally increase the size of the cross section of the second housing region, as is required in the prior art. Instead, it is possible to directly couple a drive pinion of the drive motor to an input pinion of the gear mechanism.

Advantageous developments of the handheld power tool according to the disclosure are specified below. All combinations of at least two of the features disclosed herein, the description and/or the figures fall within the scope of the disclosure.

In a particularly preferred refinement of the disclosure, provision is made for a receptacle for a drive rechargeable battery to be arranged on that side of the second region which is opposite the first region of the housing. This allows direct and relatively simple electrical coupling between the drive rechargeable battery and the switching device which can be produced in a cost-effective manner and operates in a particularly reliable manner. Furthermore, the center of gravity of the handheld power tool is positively influenced by the drive rechargeable battery, which is arranged at the lower end of the second housing region, in such a way that this allows a user to handle said handheld power tool in a particularly effective and simple manner.

It is very particularly preferred for the drive motor to be in the form of an electrically commutated drive motor. An electrically commutated drive motor of this kind has the advantage of a particularly compact design and particularly high power, based on its overall size, and therefore the second region of the housing can furthermore be particularly compact and, for example, it is also possible to guide an operating element of the switching device in the region of the drive motor with relatively little additional space being required.

Furthermore, provision is preferably made for the longitudinal axis of the drive motor to be arranged at least substantially perpendicular to the longitudinal axis of the tool holder. As a result, relatively simple and cost-effective components can be used for transmitting force from the drive motor to the gear mechanism.

In this case, provision is made, in particular, for the drive shaft of the drive motor to act on a gear wheel, which at least indirectly forms an input shaft of the gear mechanism, by means of a drive pinion. In order to avoid bending stresses in the input shaft of the gear mechanism, provision can be made in this case for the input shaft to be mounted in a respective bearing device on either side of the gear wheel.

A housing which is particularly compact in the longitudinal direction, that is to say in the longitudinal direction of the tool holder, can be achieved when the gear mechanism is arranged with an at least partial overlap with the drive motor in its longitudinal direction.

### BRIEF DESCRIPTION OF THE DRAWING

Further advantages, features and details of the disclosure can be gathered from the following description of preferred exemplary embodiments and with reference to the drawing. In said drawing, the single FIGURE shows a simplified longitudinal section through a handheld power tool according to the disclosure.

### DETAILED DESCRIPTION

The single figure illustrates a handheld power tool 10 in a highly simplified manner. In this case, the handheld power tool 10 is, in particular, in the form of a power drill or a power screwdriver. To this end, the handheld power tool 10 has a tool holder 11 which is in the form of a spindle and into which a tool, for example a bit insert or a drill, can be clamped or locked in the conventional manner.

The handheld power tool 10 has a housing 13 which consists, for example, of two half-shells and, in particular, is in the form of an injection-molded part, the plane of separation of said housing being parallel to the plane of the drawing. The housing 13 has essentially two housing regions 14, 15, wherein the first housing region 14 is oriented at least substantially in line with the longitudinal axis 16 of the tool holder 11. The second housing region 15 of the housing 13 is arranged at least substantially perpendicular to the first housing region 14 and forms a handle 17 which can be used by a user to hold the handheld power tool.

A drive rechargeable battery 20 which is attached, such that it can be exchanged, to the housing 13 in the conventional manner is arranged on the housing 13 on that side of the second housing region 15 which is averted from the first housing region 14. To this end, the housing 13 or its second housing region 15 has correspondingly formed holding or attachment elements.

The drive shaft 21 of the tool holder 11 is coupled to a gear mechanism 22 which is in the form of a 2-gear mechanism in the exemplary embodiment. In this case, the drive shaft 21 forms, in particular, the output shaft of the gear mechanism 22. A sliding switch 23 by means of which the operator can switch the gear mechanism 22 to the respective, desired gear is arranged on the upper face of the housing 13 on that side which is averted from the second housing region 15. On that side of the gear mechanism 22 which is opposite the drive shaft 21, said gear mechanism has an input shaft 24 which is supported in the housing 13 by means of two bearings 25, 26. A crown gear 27 is arranged between the two bearings 25, 26, the tooth system 28 of said crown gear meshing with a drive pinion 29 of a drive motor 30.

The drive motor 30 is preferably in the form of an electrically commutated drive motor 30 and is arranged on that side of the second housing region 15 which faces the first housing region 14. In this case, the drive pinion 29 projects into the first housing region 14 of the housing 13.

The longitudinal axis 32 of the drive motor 30 is arranged, in particular, substantially perpendicular to the input shaft 24 of the gear mechanism 22.

A switching device 35 is arranged inside the housing 13 on that side of the second housing region 15 which is averted from the first housing region 14, the drive motor 30 being driven or controlled by means of said switching device. In this case, the switching device 35 is electrically connected or coupled firstly to the drive rechargeable battery 20 and secondly to the drive motor 30. It is important here for the drive motor 30 to be arranged between the switching device 35 and the gear mechanism 22, with said drive motor being arranged with a partial overlap with the gear mechanism 22 with respect to the longitudinal axis 32 of the drive motor 30.

The switching device 35 has a switch 38 which can be manually operated at a pivot point 36 in the direction of the double-headed arrow 37 and which is force-operated by a tension spring 39 and by means of which the current flowing from the drive rechargeable battery 20 to the drive motor 30 can be controlled or regulated. In this case, the switch 38 is arranged approximately level with the drive motor 30 and can be manually operated by the operator's fingers.

The handheld power tool 10 described thus far can be altered or modified in various ways without departing from the concept of the invention. In particular, other embodiments of the handheld power tool 10 in respect of its use are also feasible. In particular, the handheld power tool 10 should not be restricted to an embodiment as a power drill or battery-powered screwdriver.

What is claimed is:

1. A handheld power tool, comprising:
a drive motor;
a switching device configured to operate the drive motor; and
a housing that includes a first region for a tool holder and a second region configured as a handle, the tool holder being coupled to the drive motor by a gear mechanism, and both the drive motor and the switching device being arranged in the second region of the housing,
wherein the drive motor is arranged in the second region of the housing on a side which faces the gear mechanism.

2. A handheld power tool according to claim 1, further comprising a receptacle for a drive rechargeable battery which is arranged on the side of the second region which is opposite the first region of the housing.

3. A handheld power tool according to claim 1, wherein the drive motor is an electrically commutated drive motor.

4. A handheld power tool according to claim 1, wherein a longitudinal axis of the drive motor is arranged at least substantially perpendicular to a longitudinal axis of the tool holder.

5. A handheld power tool according to claim 4, wherein the drive shaft of the drive motor is configured to act on a gear wheel, which at least indirectly forms an input shaft of the gear mechanism, by a drive pinion.

6. A handheld power tool according to claim 5, wherein the input shaft is mounted in a respective bearing device on either side of the gear wheel.

7. A handheld power tool according to claim 1, wherein the switching device has a switch configured to be manually operated and which is arranged in the region of the drive motor by way of a section which can be operated by an operator.

8. A handheld power tool according to claim 1, wherein the gear mechanism is arranged with an at least partial overlap with the drive motor in its longitudinal direction.
